(19) United States
(12) Patent Application Publication
(10) Pub. No.: US 2009/0114190 A1
(43) Pub. Date: May 7, 2009

(54) High pressure pump and method of reducing fluid mixing within same

(75) Inventors: Scott Shafer, Muncie, IN (US); Bradley E. Bartley, Pekin, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/982,013

(22) Filed: Nov. 1, 2007

(51) Int. Cl. F02M 37/04; F04B 15/00; F02M 59/02

(52) U.S. Cl. 123/446; 417/437; 137/565.01; 123/495

(57) ABSTRACT

To reduce mixing of fluids within a high pressure pump, a pump is provided that comprises a housing, a piston, an annulus, and a first seal. The housing includes an inlet for a first fluid, an inlet for a second fluid, and a piston bore fluidly coupled to the inlet for the first fluid. The piston is moveable within the piston bore and has a first end exposed to the first fluid and a second end exposed to the second fluid. The annulus is defined within the piston bore and is configured to be fluidly coupled to a drain circuit having a pressure less than the pressure of the first fluid. The first seal is coupled to the housing and is located outside of the piston bore. The first seal engages the piston to create a seal that substantially prevents the second fluid from entering the piston bore.

### TECHNICAL FIELD

The present disclosure relates generally to high pressure pumps, and more specifically to reducing fluid mixing within a high pressure pump.

### BACKGROUND

Lubrication fluid, such as oil, is generally pumped through a fluid pump in order to lubricate the moving parts of the pump. Mixing of the lubrication fluid with the fluid being pumped can undermine the lubricity of the lubrication fluid and/or contaminate the fluid being pumped with the lubrication fluid. For example, many fuel systems include a low pressure transfer pump that draws fuel from a fuel tank and a high pressure pump that increases the pressure of the fuel before injection. Lubrication fluid, generally oil, flows within the high pressure pump to lubricate the moving parts. Cam-driven, reciprocating pistons within piston bores of the high pressure pump increase the pressure of the fuel. The reciprocating motion of the piston and the pressure within the piston bore can cause some of the fuel to migrate between the piston and the piston bore. If the fuel is permitted to migrate outside of the piston bore and into a cam-housing region, the fuel will directly mix with oil, decreasing the lubrication quality of the lubrication oil, which can lead to potentially serious problems throughout the lubrication system. At the same time, if the oil is permitted to migrate between the piston and the piston bore and mix with fuel that is ultimately injected into the combustion chamber, the oil content of the fuel may result in an increase in undesirable particulate matter emitted from the combustion chamber. The increase in particulate matter may cause more particulate matter to be emitted into the atmosphere or may put an additional burden on a diesel particulate filter or other aftertreatment systems.

In order to reduce the fuel migration between the reciprocating piston and the piston bore, it is known to position a seal, such as an o-ring, between the piston bore and the reciprocating piston to block the migration of the fuel into the lubrication oil system. However, many fluid pumping reciprocating pistons can be subjected to relatively extreme pressure changes, thereby reducing the life and the sealing capability of the seals.

In order to relieve the pressure on an o-ring, and further reduce fluid mixing, a fluid seal, described in U.S. Pat. No. 5,901,686, issued to Stockner et al. on May 11, 1999, is designed for a fuel injector that includes a reciprocating piston within a piston bore including a pressurization chamber in which fuel pressure is increased. The fluid seal includes an annular pressure accumulation volume defined by the piston and positioned between the pressurization chamber and the o-ring. A fuel injector body defines a pressure release passage, positioned between the accumulation volume and the pressurization chamber when the plunger is in the retracted position, that fluidly connects the piston bore to a low pressure return line.

As fuel migrates between the piston bore and the piston when the piston advances to pressurize the fuel within the pressurization chamber, pressure on the o-ring is reduced by some of the fuel flowing from the bore to the pressure release passage while another portion of the fuel accumulates within the pressure accumulation volume. When the pressure accumulation volume of the advancing piston is aligned with the pressure release passage, the pressure on the o-ring dramatically drops as a result of the pressure accumulation volume dropping to the same low pressure as the low pressure return line. The pressure within the accumulation volume will again build when the piston advances past the pressure release passage until the injection event ends.

Although the pressure on the o-ring is reduced by the combination of the pressure accumulation volume and the pressure release passage, the fuel migrating up the piston bore is still permitted to migrate and accumulate within the piston bore for the majority of the pressure stroke of the piston. Only for the brief time that the pressure accumulation volume is fluidly connected to the pressure release passage is the fuel within the pressure accumulation volume able to evacuate from the piston bore.

The present disclosure is directed at overcoming one or more of the problems set forth above or other problems.

### SUMMARY

According to one exemplary embodiment, a pump comprises a housing, a piston, an annulus, and a first seal. The housing includes an inlet for a first fluid, an inlet for a second fluid, and a piston bore fluidly coupled to the inlet for the first fluid. The piston is moveable within the piston bore and has a first end exposed to the first fluid and a second end exposed to the second fluid. The annulus is defined within the piston bore and is configured to be fluidly coupled to a drain circuit having a pressure that is less than the pressure of the first fluid. The first seal is coupled to the housing and is located outside of the piston bore. The first seal engages the piston to create a seal that substantially prevents the second fluid from entering the piston bore.

According to another exemplary embodiment, a fuel system comprises a source of fuel, a source of lubrication fluid, a low pressure pump, a high pressure pump, and at least one fuel injector. The low pressure pump includes a low pressure pump inlet and a low pressure pump outlet. The low pressure pump inlet is fluidly coupled to the source of fuel. The high pressure pump includes a housing, a piston, an annulus, and a first seal. The housing includes a high pressure pump inlet fluidly coupled to the low pressure pump outlet, a high pressure pump outlet, a lubrication fluid inlet coupled to the source of lubrication fluid, and a piston bore fluidly coupleable to the high pressure pump inlet and the high pressure pump outlet. The piston is moveable within the piston bore and has a first end exposed to the fuel and a second end exposed to the lubrication fluid. The annulus is defined within the piston bore and is fluidly coupled to the low pressure pump inlet. The first seal is coupled to the housing. The at least one fuel injector is fluidly coupled to the high pressure pump outlet. The first seal engages the piston to create a seal that substantially prevents the lubrication fluid from entering the piston bore.

According to another exemplary embodiment, a method is disclosed for substantially preventing a first fluid within a first chamber from mixing with a second fluid within a second chamber, where the first chamber and the second chamber are located on opposites ends of a bore and are separated by a component moveable within the bore. The method comprises the step of pressurizing the first fluid to a first pressure. The method also comprises the step of fluidly coupling a fluid drain to a first portion of the bore. The method further comprises the step of maintaining the fluid drain at a drain pressure lower than the first pressure. The method also comprises the step of wiping the second fluid from the component as the component moves within the bore.

### BRIEF DESCRIPTION OF THE DRAWINGS

FIG. 1 is a schematic illustration of a fuel system, according to one embodiment the present disclosure.

FIG. 2 is an isometric view of a compound pump assembly of the fuel system of FIG. 1.

FIG. 3 is a side sectioned view along line AA of a high pressure pump of the compound pump assembly of FIG. 2.

FIG. 4 is a sectioned view of a portion of a high pressure pump according to another embodiment of the present disclosure.

### DETAILED DESCRIPTION

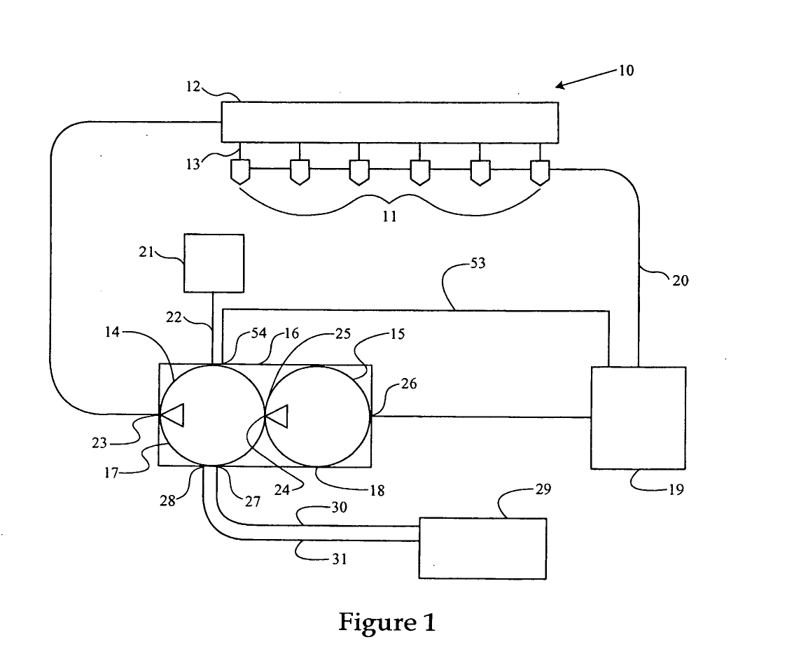

Referring to FIG. 1, there is shown a schematic illustration of a fuel system 10, according to the present disclosure. The fuel system 10 includes a plurality of fuel injectors 11, which are each connected to a high pressure fuel rail 12 via individual branch passages 13. The high pressure fuel rail 12 is supplied with high pressure fuel from a high pressure pump 14 that is supplied with relatively low pressure fuel by a low pressure pump 15. A high pressure pump housing 17 of the high pressure pump 14 defines a high pressure pump outlet 23 fluidly connected to the fuel common rail 12 and a return line outlet 54 fluidly connected to a fuel tank 19 via a first return line 53. A low pressure pump housing 18 of the low pressure pump 15 defines a low pressure pump inlet 26 fluidly connected to the fuel tank 19, which is also fluidly connected to the fuel injectors 11 via a second return line 20. Although the present disclosure contemplates the high pressure pump 14 and the low pressure pump 15 being separate from one another in separate housings, in the illustrated embodiment, the low pressure pump 15 and the high pressure pump 14 may be both included within a compound pump assembly 16. The high pressure pump housing 17 of the high pressure pump 14 may be attached to the low pressure pump housing 18 of the low pressure pump 15 in a conventional manner, such as through the use of bolts. The low pressure pump housing 18 defines a low pressure pump outlet 25 that is fluidly connected to a high pressure pump inlet 24 defined by the high pressure pump housing 17. The high pressure pump housing 17 also defines a lubrication fluid inlet 27 and a lubrication fluid outlet 28. The lubrication fluid inlet 27 and the lubrication fluid outlet 28 are fluidly connected to a source of lubrication fluid 29, illustrated as an engine oil sump, via a lubrication supply line 30 and a lubrication return line 31, respectively.

The fuel system 10 is controlled in its operation in a conventional manner via an electronic control module 21 which is connected to the high pressure pump 14 via a pump communication line 22 and connected to each fuel injector 11 via communication lines (not shown). When in operation, control signals generated by the electronic control module 21 determine how much fuel displaced by the high pressure pump 14 is forced into the common rail 12 and at what time, as well as when and for what duration (indicative of fuel injection quantity) fuel injectors 11 operate. The fuel not delivered to the fuel common rail 12 can be re-circulated back to the fuel tank 19 via the first return line 53.

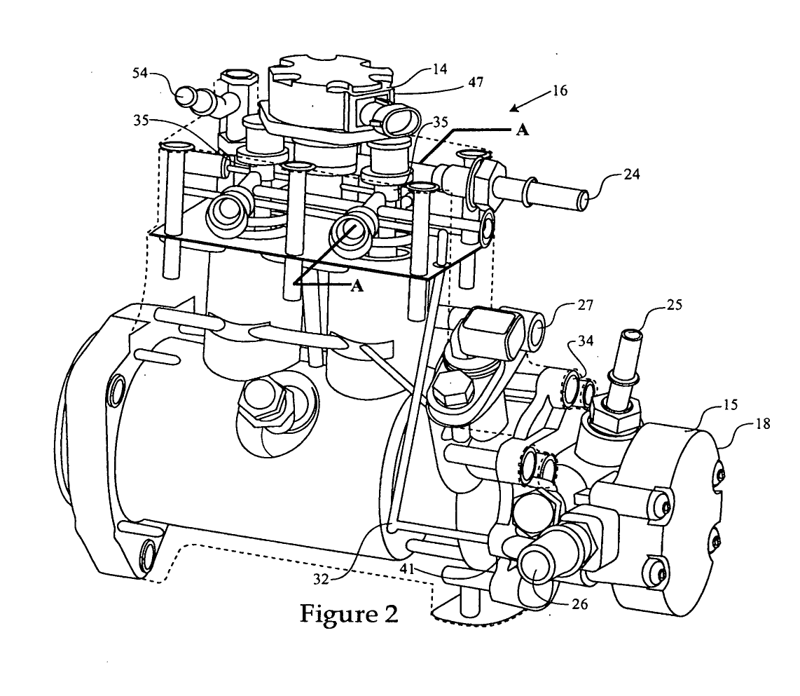

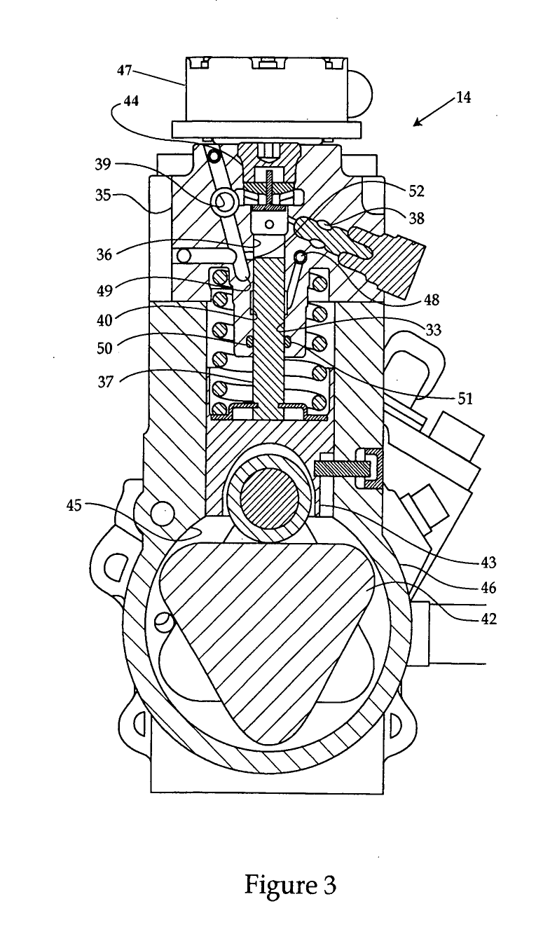

Referring to FIG. 2, there is shown an isometric view of the compound pump assembly 16 within the fuel system 10 of FIG. 1. It should be appreciated that a portion of the high pressure pump housing 17 and a fluid communication line connecting the low pressure pump outlet 25 with the high pressure pump inlet 24 have been removed from the compound pump assembly 16 in order to illustrate the internal structure of the high pressure pump 14. A perimeter of the high pressure pump housing 17 is illustrated by a dotted line. The low pressure pump housing 18 defines a plurality of bolt bores 34 through which the high pressure pump housing 17 can be bolted to the low pressure pump housing 18. The high pressure pump housing 17 includes two barrels 35, each defining, in part, a piston bore 33 (shown in FIG. 3). A drain line 32 fluidly connects two annuluses 40 (shown in FIG. 3), each opening to a respective piston bore 33, to the low pressure pump inlet 26 of the low pressure pump 15, which acts as a drain circuit for the annuluses 40. Although the illustrated embodiment includes two piston bores, it should be appreciated that the pump 14 could include any number of piston bores, each opened to an annulus. The drain line 32 may be attached to the low pressure pump inlet 26 via a conventional T-connection 41. Thus, the drain line 32 fluidly connects the piston bore 33 which is generally at a relatively high pressure to low pressure fuel flowing into the low pressure pump 15, thereby creating a pressure differential. Those skilled in the art will appreciate that the greater the velocity of the fuel flow, the lower the pressure within the low pressure pump inlet 26. The lubrication fluid inlet 27 and outlet (not shown) allow oil to flow into and out of the high pressure pump housing 17 and lubricate the moving parts.

Referring to FIG. 3, there is shown a side sectioned view of the high pressure pump 14 of the compound pump assembly 16 of FIG. 2. The barrel 35 that is part of the pump housing 17 defines the piston bore 33 in which a piston 37 reciprocates. It should be appreciated that the piston 37 can be made from any suitable material, including various metals and ceramics. Although only one piston 37 within one piston bore 33 is illustrated, it also should be appreciated that both piston/piston bore pairs operate similarly. The piston 37 and the piston bore 33 define a pumping chamber 36 that is fluidly connectable to a high pressure gallery 38 and a low pressure fuel supply gallery 39. The high pressure gallery 38 is fluidly connected to the high pressure pump outlet 23, and the low pressure fuel supply gallery 39 is fluidly connected to the high pressure pump inlet 24. The piston 37 is coupled to a cam 42 via a tappet 43 in a conventional manner. The cam 42 rotates and the tappet 43 reciprocates within a cam region 45 defined by a cam housing 46. Although not shown, a second piston reciprocates with a second cam. According to one exemplary embodiment, the pair of cams are operable to cause the pistons to reciprocate out of phase with one another, and the cams are driven by the engine and rotate at a rate that synchronizes pumping activity to fuel injection activity. It should be appreciated that the cams, including cam 42, and the tappet 43 are lubricated by the flow of lubrication fluid. Thus, there is oil flowing within the cam region 45.

According to one exemplary embodiment, when the piston 37 is undergoing its retracting stroke, fresh low pressure fuel is drawn from the low pressure fuel supply gallery 39 past an inlet check valve 44 and into the pumping chamber 36. During this time, fluid communication between the pumping chamber 36 and the low pressure fuel supply gallery 39 via a spill control valve 47 is blocked. The spill control valve 47 includes an electrical actuator that can be used to control the spill control valve 47 during the pumping stroke in order to control the output from the pumping chamber 36. When the piston 37 is undergoing its pumping stroke and the control valve 47 is open, the pressure within the pumping chamber 36 moves a shuttle valve member (not shown) of the spill control valve 47 in order to fluidly connect the pumping chamber 36 to the low pressure fuel supply gallery 39 via the spill control valve 47. The fuel may be displaced from the pumping chamber 36 into the low pressure gallery 39 via the spill control valve 47. When the spill control valve 47 is closed, the fuel in the pumping chamber 36 will be pushed past an outlet check valve into the high pressure gallery 38 and into the high pressure common rail 12. Those skilled in the art will appreciate that the timing at which the electrical actuator is energized (e.g., the timing at which the spill control valve is opened and closed) determines what fraction of the amount of fuel displaced by the piston action is pushed into the high pressure gallery 38 and what other fraction is displaced back to the low pressure gallery 39. Because the pistons are reciprocating out of phase with one another and the pumping chamber 36 is only connected to the low pressure fuel supply gallery 39 via the spill control valve 47 during the pumping stroke, the pumping chambers 36 can share one spill control valve 47. It should be appreciated that the systems and methods described herein contemplate use with various high pressure pumps, including pumps that vary pump input or output in a different manner than illustrated and pumps that do not have any variable discharge capabilities. For example, the systems and methods described herein may also be used with a pump having an electrically actuated spill control valve associated with each piston/piston bore pair, where the spill control valve is moveable between an open position in which the low pressure fuel supply gallery is fluidly connected to the pumping chamber and a closed position in which the low pressure fuel supply gallery is disconnected from the pumping chamber. As with the embodiment described above, the timing at which the electrical actuator associated with each spill control valve is energized determines what fraction of the amount of fuel displaced by the piston action is pushed into a high pressure gallery and what other fraction is displaced back to the low pressure gallery.

According to one exemplary embodiment, the annulus 40 (also known as a weep annulus) opens to the piston bore 33 and is fluidly connected to the drain line 32 via a drain gallery 48 defined by the high pressure pump housing 17. The barrel 35 optionally defines a seal groove 50 in which seal 51 may be positioned. Seal 51 may be an o-ring, a glyd ring or an equivalent. The seal groove 50 may be positioned along the piston bore 33 between the weep annulus 40 and the cam region 45. As the piston 37 reciprocates, fuel that migrates between the piston 37 and the piston bore 33 can be drawn into the weep annulus 40 and the drain gallery 48. Because the piston bore 33 is at a higher pressure than the low pressure pump inlet 26 when the migration of the fuel normally takes place, the migrating fuel is drawn to the low pressure inlet 26 before reaching the cam region 45 in which the oil is being circulated. Any fuel not drawn into the weep annulus 40 can be sealed from the cam region 45 via the seal 51.

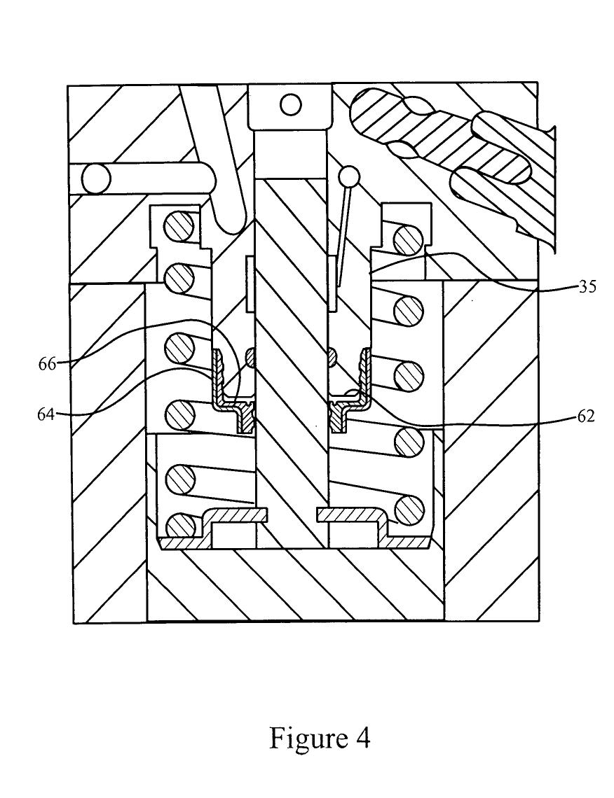

According to another exemplary embodiment illustrated in FIG. 4, the high pressure pump 14 may include a seal 60, shown as a wiper seal, that may be used in conjunction with weep annulus 40 and/or with seal 51 to reduce or minimize the mixing of oil and fuel. The wiper seal 60 may be coupled to an end 62 of the portion of barrel 35 that defines piston bore 33 (e.g., the wiper seal may be located outside of the piston bore 33 or within a counterbore formed in the end of piston bore 33) and is configured to wipe or scrape any oil from the outside of piston 37 before it enters piston bore 33. As the piston 37 reciprocates within the piston bore 33, a portion of the piston 37, referred to here as the middle portion, will move into and out piston bore 33. When the piston 37 is in the retraced position, the middle portion will be outside of the piston bore 33 and will generally be exposed to lubrication fluid. As the piston 37 moves during its pressure stroke and reaches the extended position, the middle portion will have entered piston bore 33. As the middle portion enters the piston bore 33 during the pumping stroke, any lubrication fluid on the outside of the middle portion may be dragged along with the middle portion into the piston bore 33 unless there is something to stop it. If the lubrication fluid enters the piston bore 33, it is more likely to work its way between the piston 37 and the piston bore 33 and mix with fuel and be drawn into the weep annulus 40, where it will enter the fuel system and eventually make its way to the combustion chamber. This is more likely when the pressure of the lubrication fluid is greater than that of the fluid within the weep annulus 40. The wiper seal 60 is intended to remove most, if not all, of the oil from the middle portion of the piston 37 before it enters the piston bore 33. If the seal 51 is used, the seal 51 serves as a secondary seal to help prevent lubrication fluid from mixing with fuel and being evacuated through the weep annulus 40.

According to one exemplary embodiment, the wiper seal 60 includes a generally rigid infrastructure or base portion 64 that provides the structure to define and maintain the general shape of the wiper seal 60. The wiper seal 60 also includes a sealing portion 66 that includes the structure that actually contacts the piston 37 and removes the lubrication fluid therefrom. According to one exemplary embodiment, the sealing portion includes two projections that engage the piston 37. According to various alternative and exemplary embodiments, the wiper seal may take any one of a variety of different shapes and configurations that are suitable for wiping, scraping, or otherwise removing lubrication fluid from the piston before it enters the piston bore. For example, the sealing portion may include one, three, four, or more than four projections or elements that engage the piston. According to other various alternative and exemplary embodiments, the base portion 64 and the sealing portion 66 are made from different materials, the base portion being made of any material suitable to maintain its shape in the operating environment of the pump 14 and the sealing portion being made of any material suitable to engage the piston in a manner that creates a seal in the operating environment of the pump 14. According to other alternative and exemplary embodiments, the wiper seal may be bi-directional, such that it is effective to remove lubrication fluid from the piston regardless of the direction the piston is traveling, or it may be unidirectional such that it is only effective to remove lubrication fluid from the piston when the piston is moving into the piston bore. According to another alternative embodiment, instead of being located outside of the piston bore, the wiper seal may be located within the piston bore between the weep annulus and the end of the portion of the barrel defining the piston bore.

The high pressure pump housing 17 may optionally define a debris basin 49 fluidly connected to the low pressure fuel supply gallery 39. The debris basin 49 is a cavity defined by the barrel 35 that extends below the bottom fill port 52 connected to the pumping chamber 36. Thus, gravity can pull debris that is heavier than the fuel entering the bottom fill port 52 into the debris basin 49 rather than allow it to enter the pumping chamber 36. Optionally, the present disclosure includes a debris basin for each piston bore.

### INDUSTRIAL APPLICABILITY

Referring to FIGS. 1-4, systems for, and methods of, reducing fluid mixing within the high pressure pump 14 of the compound pump assembly 16 will be discussed. Although the operation of the systems and methods will be discussed in connection with the fuel system 10, it should be appreciated that they can work similarly for any fluid system including a low pressure fluid pump and a high pressure fluid pump. Moreover, the low pressure pump and the high pressure pump need not be part of a compound pump as illustrated. Further, although the systems and methods described herein will be discussed in connection with one piston bore 33, it should be appreciated that they operate similarly for multiple piston bores.

Lubrication fluid, illustrated in the present disclosure as oil, is supplied to the high pressure pump 14 from the source of lubrication fluid 29 via the lubrication fluid supply line 30. The oil is generally drawn from the source 29 via a pump (not shown) and circulated through the cavities of the high pressure pump 14, including the cam region 45 defined by the cam housing 46. The oil will lubricate the moving cam 42 and the tappet 43. The oil returns to the lubrication fluid source 29 via the lubrication drain line 31.

A second fluid, being fuel, is pumped from the fuel tank 19 to the high pressure pump 14 via the low pressure pump 15. It should be appreciated that although the high pressure pump housing 17 is attached to the low pressure pump housing 18, the present disclosure contemplates the two pumps being separated and detached from one another. The fuel will flow from the low pressure pump outlet 25 to the high pressure pump inlet 24 and into the low pressure fuel supply gallery 39 of the high pressure pump 14 until drawn into a pumping chamber 36 for pressurization.

The pressure of the fuel is increased within the pumping chamber 36 within the piston bore 33 of the high pressure pump 14. Although the present disclosure discusses only one piston 37/piston bore 33 pair, it should be appreciated that the second piston/piston bore pair operates similarly, except that the pistons reciprocate out of phase with one another. Moreover, it should be appreciated that the present disclosure could be used with a pump having any number of piston bores, including only one, or with a pump that utilizes one spill control valve for each bore. As piston 37 undergoes its retracting stroke, fuel will be drawn into the pumping chamber 36 via the low pressure fuel supply gallery 39. Because the spill control valve 47 does not fluidly connect the low pressure fuel supply gallery 39 with the pumping chamber 36 while the piston 37 is retracting, the fuel will flow into the pumping chamber 36 via the inlet check valve 44 and bottom fill port 52. Positioned below the bottom fill port 52 and fluidly connected to the low pressure fuel supply gallery 39 may be the debris basin 49. The debris basin 49 is a cavity that can collect debris from the fuel within the low pressure fuel supply gallery 39 before the fuel flows into the bottom fill port 52. Due to gravity, at least some of the debris may separate from the fuel and collect in the debris basin 49 while the fuel is drawn into the pumping chamber 36 via the bottom fill port 52. Because the debris is separated from the fuel and kept out of the pumping chamber 36, the debris is less likely to interfere with the motion of the piston 37 and cause pump seizure.

As the piston 37 undergoes its pumping stroke, the pumping chamber 36 will be either fluidly connected to the low pressure fuel supply gallery 39 via the spill control valve 47 or fluidly connected to the high pressure gallery 38, depending on the position of the spill control valve 47. When the spill control valve 47 is open, the advancing piston 37 will push the fuel into the low pressure supply gallery 39. When there is a desire to output high pressure fuel from the pump 14, the electrical actuator of the spill control valve 47 is activated, thereby closing the spill control valve 47 and blocking the flow of fuel to the low pressure supply gallery 39 and forcing the pressurized fuel to flow past the outlet check valve and into the high pressure gallery 38. Although the present disclosure includes a single spill control valve 47 to control the fuel output from the pump 14, it should be appreciated that the present disclosure contemplates use with multiple spill control valves, and with pumps without spill control valves and/or without variable discharge capabilities.

Referring now to FIGS. 3 and 4, as the piston 37 advances, the increased pressure within the pumping chamber 36 can cause some of the fuel to migrate between the piston 37 and the sides of the piston bore 33. The retracting action of the piston 37 can also drag some of the fuel between the piston 37 and the piston bore 33. Similarly, as the piston 37 advances, the piston 37 will tend to want to drag some of the lubrication fluid into the piston bore 33. Moreover, to the extent the pressure of the fluid within the weep annulus 40 is less than the pressure of the lubrication fluid, the lubrication fluid will tend to want to flow toward the weep annulus 40.

According to one exemplary embodiment, the mixing of the fuel with the oil is reduced, at least in part, by fluidly connecting the weep annulus 40 to the low pressure inlet 26 of the low pressure pump 15. As the fuel migrates down the piston bore 33 and the piston 37, the fuel will reach the weep annulus 40. The pressure differential between the piston bore 33 and the low pressure fuel flowing into the low pressure pump inlet 26 will draw the fluid from the weep annulus 40 to the low pressure pump inlet 26 via the drain gallery 48 and drain line 32. Because the drain line 32 is fluidly connected to the low pressure inlet 26 via the T-connection 41, the drain line 32 is fluidly connected to the flow of the low pressure fuel from the fuel tank 19 to the low pressure pump 15. Thus, the T-connection 41 may further increase the pressure differential that causes evacuation of the weep annulus 40.

According to another exemplary embodiment, the mixing of the oil with the fuel is reduced, at least in part, by providing the wiper seal 60 at the entrance to the piston bore 33. Before the middle portion of the piston 37 moves into the piston bore 33, the middle portion will move through the wiper seal 60, which should wipe or remove most, if not all, of the oil from the side of the piston 37. The wiper seal 60 should not only help to significantly reduce the amount of oil that is dragged into the piston bore 33 by the piston 37, it should also help to provide a seal around piston 37 that will prevent, or at least substantially prevent, any static leakage of the oil into the piston bore 33. By significantly limiting, or preventing, the passage of oil into the parts of the piston bore 33 in which the fuel is located, any oil to fuel migration can be significantly reduced or prevented.

If any fuel is not evacuated through the weep annulus 40, but rather continues to migrate down the piston bore 33, the seal 51 can seal the fuel within the piston bore 33 from the oil within the cam region 45. Similarly, the seal 51 can provide a seal that can help prevent any oil that makes it past the wiper seal 60 and that is drawn into the piston bore 33 via the reciprocating action of the piston 37 from mixing with the fuel. Essentially, the seal 51, if provided, serves as a secondary seal to both the weep annulus 40 and the wiper seal 60. Thus, in order for fuel to make its way into the oil within cam region 45, the fuel must migrate past the weep annulus 40, the seal 51, and the wiper seal 60. Similarly, in order for oil to make its way into fuel that is ultimately sent to the combustion chamber, the oil must migrate past both the wiper seal 60 and the seal 51. However, according to various alternative embodiments, the inclusion of the seal 51 may not be necessary and the seal 51 may be excluded.

As discussed above, if some oil does migrate past the wiper seal 60 and the seal 51, the oil will be drawn into the weep annulus 40 and circulated back through the pumps 14 and 15, forwarded to the fuel injectors 11 and burned with other fuel. Although the presence of oil within the fuel system is not as likely to cause the structural damage that can be caused by the presence of fuel in the lubrication system, the presence of the oil within the fuel system is likely to lead to increased levels of particular matter being emitted from the combustion chamber. For engines without aftertreatment systems, the increased levels of particulate matter that are emitted by the engine as a result of the oil within the fuel may make it difficult to operate the engine in compliance with emissions regulations (depending on what the applicable regulations are). For engines with aftertreatment systems, the increased levels of particulate matter put an additional burden on the aftertreatment system. For example, increased particulate matter levels may lead to more frequent regeneration of a diesel particular filter, which in turn may have the effect of shortening the life of the diesel particular filter. Thus, although the presence of oil within the fuel system may not lead as directly to the structural failure of certain components, it is desirable in many situations to keep the levels of particulate matter to a minimum.

The systems and methods described herein may be advantageous because they reduce the risk of fluid mixing due to fuel to oil migration, oil to fuel migration, and debris within the piston bore 33. In order to reduce fuel to oil migration, one embodiment of the systems and methods described herein utilizes the pressure differential between the low pressure fluid flowing into the low pressure pump inlet 26 and the pressure within the weep annulus 40 to continuously draw the fuel from the weep annulus 40. Because the pressure within the piston bore 33 generally remains at a higher pressure than the pressure of the low pressure pump inlet 26, the fuel migrating to the weep annulus 40 will be continuously evacuated through the drain line 32 rather than migrating down the piston bore 33 and into the oil within the cam region 45. The T-connection 41 between the drain line 32 and low pressure pump inlet 26 may further increase the pressure differential, and thus, the suction drawing the fuel away from the piston bore 33. In order to reduce oil to fuel migration, one embodiment of the systems and methods described herein utilizes a wiper seal 60 that wipes or removes oil from the middle portion of the piston 37 before the middle portion enters the piston bore 33 and that serves as a static seal that substantially prevents the leakage of oil past the wiper seal 60 and into the piston bore 33 where it is more likely to make its way to the weep annulus 40. In addition, the optional seal 51 may be added protection against fuel to oil mixing and oil to fuel mixing by sealing the piston bore 33 from the cam region 45 and vice versa. Because the mixing of fuel and oil is reduced, the high pressure pump 14 and other engine components can be more sufficiently lubricated by the oil, leading to a longer life and more efficient operation, and the fuel delivered to the fuel injectors can be free of oil, leading to reduced emissions.

The systems and methods described herein may also be advantageous because the high pressure pump 14 may be more debris-resistant, meaning the likelihood that debris within the fuel will enter the pumping chamber 36 is reduced. Gravity may be utilized to separate at least some of the debris from the fuel before it flows into the pumping chamber 36. The weight of the debris will cause the debris to collect in the debris basin 49 while the fuel flows into the pumping chamber 36 via the bottom fuel port 52. Because at least some of the debris is separated from the fuel before it enters the pumping chamber 36, the risk of the debris interfering with the reciprocating action of the piston 37 is reduced, thereby increasing the likelihood that the pump 14 will function properly.

It should be understood that the description provided herein is intended for illustrative purposes only, and is not intended to limit the scope of the systems and methods described herein in any way. Thus, those skilled in the art will appreciate that other aspects, objects, and advantages of the disclosed systems and methods can be obtained from a study of the drawings, the disclosure and the appended claims.

What is claimed is:

1. A pump comprising:
a housing including an inlet for a first fluid, an inlet for a second fluid, and a piston bore fluidly coupled to the inlet for the first fluid;
a piston moveable within the piston bore and having a first end exposed to the first fluid and a second end exposed to the second fluid;
an annulus defined within the piston bore and configured to be fluidly coupled to a drain circuit having a pressure that is less than the pressure of the first fluid; and
a first seal coupled to the housing and being located outside of the piston bore;
wherein the first seal engages the piston to create a seal that substantially prevents the second fluid from entering the piston bore.

2. The pump of claim 1, wherein the first seal is a wiper seal.

3. The pump of claim 2, further comprising a second seal located between the annulus and the first seal.

4. The pump of claim 3, wherein the second seal is located within a seal groove within the piston bore.

5. The pump of claim 1, wherein the first fluid is fuel and the second fluid is oil.

6. The pump of claim 1, wherein a pumping chamber is provided at the first end of the piston bore and a cam region is provided at the second end of the piston bore.

7. The pump of claim 6, wherein the cam region is fluidly coupled to the inlet for the second fluid.

8. The pump of claim 1, wherein the annulus is configured to be fluidly coupled to a drain circuit having a pressure that is less than the pressure of the second fluid within the housing.

9. The pump of claim 1, wherein the first seal includes a base portion and a sealing portion and wherein the sealing portion includes at least two projections that engage the piston.

10. The pump of claim 9, wherein the base portion is a different material than the sealing portion.

11. A fuel system comprising:
a source of fuel;
a source of lubrication fluid;
a low pressure pump including a low pressure pump inlet and a low pressure pump outlet, the low pressure pump inlet being fluidly coupled to the source of fuel;
a high pressure pump including:
a housing including a high pressure pump inlet fluidly coupled to the low pressure pump outlet, a high pressure pump outlet, a lubrication fluid inlet coupled to the source of lubrication fluid, and a piston bore fluidly coupleable to the high pressure pump inlet and the high pressure pump outlet;
a piston moveable within the piston bore and having a first end exposed to the fuel and a second end exposed to the lubrication fluid;
an annulus defined within the piston bore and fluidly coupled to the low pressure pump inlet; and
a first seal coupled to the housing;
at least one fuel injector fluidly coupled to the high pressure pump outlet;
wherein the first seal engages the piston to create a seal that substantially prevents the lubrication fluid from entering the piston bore.

12. The fuel system of claim 11, wherein the first seal is located outside of the piston bore.

13. The fuel system of claim 11, wherein the first seal is a wiper seal.

14. The fuel system of claim 11, further comprising a second seal located between the annulus and the first seal.

15. The fuel system of claim 14, wherein the second seal is located within a seal groove within the piston bore.

16. The fuel system of claim 11, wherein a pressure of the low pressure pump inlet is less than a pressure of the fuel within the piston bore.

17. The fuel system of claim 11, wherein the first seal includes a base portion and a sealing portion and wherein the sealing portion includes at least two projections that engage the piston.

18. A method for substantially preventing a first fluid within a first chamber from mixing with a second fluid within a second chamber, the first chamber and the second chamber being located on opposites ends of a bore and being separated by a component moveable within the bore, the method comprising the steps of:
pressurizing the first fluid to a first pressure;
fluidly coupling a fluid drain to a first portion of the bore;
maintaining the fluid drain at a drain pressure lower than the first pressure;
wiping the second fluid from the component as the component moves within the bore.

19. The method of claim 18, wherein the step of wiping the second fluid from the component includes the step of wiping the second fluid from the component from a location outside of the bore.

20. The method of claim 18, further comprising the step of diverting any of the first fluid that leaks between the component and the bore to the fluid drain.
